(19) United States
(12) Patent Application Publication
(10) Pub. No.: US 2025/0322488 A1
(43) Pub. Date: Oct. 16, 2025

(54) LIMITING SIMULTANEOUS LOCALIZATION AND MAPPING MAP SIZES

(71) Applicant: GOOGLE LLC, Mountain View, CA (US)

(72) Inventors: Thomas Friel Allen, El Cerrito, CA (US); Yong-Dian Jian, Campbell, CA (US); Chao Guo, Los Altos, CA (US)

(21) Appl. No.: 19/180,800

(22) Filed: Apr. 16, 2025

Related U.S. Application Data
(60) Provisional application No. 63/634,721, filed on Apr. 16, 2024.

(51) Int. Cl. G06T 3/40

(52) U.S. Cl. CPC G06T 3/40

(57) ABSTRACT

A method including obtaining a plurality of keyframes, the plurality of keyframes includes a spatially redundant keyframe, in response to determining that the plurality of keyframes includes a spatially redundant keyframe, updating a map associated with a surrounding environment, the map being associated with the plurality of keyframes, including removing data associated with at least one keyframe of the plurality of keyframes based on the spatially redundant keyframe and adding at least one keyframe to the plurality of keyframes.

### CROSS REFERENCE TO RELATED APPLICATION

This application claims the benefit of U.S. Provisional Application No. 63/634,721, filed Apr. 16, 2024, the disclosure of which is incorporated herein by reference in its entirety.

### BACKGROUND

Simultaneous Localization and Mapping (SLAM) is a technology for robots and/or augmented reality (AR) applications, enabling robot and/or AR applications to navigate and interact with their environments. SLAM includes simultaneously building a map of an unknown environment (mapping) while determining its own location within that map (localization). SLAM algorithms utilize data from various sensors like cameras, lidar (light detection and ranging), radar, and inertial measurement units (IMUs) to perceive the environment and estimate the device's motion. These algorithms process the sensor data to identify unique features or landmarks in the environment and track how these features move relative to the device over time.

### SUMMARY

Keyframing, a technique that selects specific frames to optimize the SLAM process, can reduce computational demand. Keyframes accumulate over time, leading to an ever-growing map size. Example implementations implement spatial keyframing. Spatial keyframing involves marginalizing older batches of keyframes when a new batch of keyframes covers roughly the same position/orientation. Marginalizing includes identifying elements that are included in the new keyframe, saving keyframes including elements that are not in the map, and discarding the keyframes that include elements that are in the map. As keyframes arrive they are batched (e.g., grouped) into epochs. An epoch is a period of time over which data (e.g., keyframes) are collected and/or batched. Some of the keyframes in the epoch may be marginalized and thus are not considered for spatial keyframing. In other words, the keyframes that a discarded as part of a marginalization process may not be considered for spatial keyframing.

In a general aspect, a device, a system, a non-transitory computer-readable medium (having stored thereon computer executable program code which can be executed on a computer system), and/or a method can perform a process with a method including obtaining a plurality of keyframes, the plurality of keyframes includes a spatially redundant keyframe, in response to determining that the plurality of keyframes includes a spatially redundant keyframe, updating a map associated with a surrounding environment, the map being associated with the plurality of keyframes including removing data associated with at least one keyframe of the plurality of keyframes based on the spatially redundant keyframe and adding at least one keyframe to the plurality of keyframes.

### BRIEF DESCRIPTION OF THE DRAWINGS

Example implementations will become more fully understood from the detailed description given herein below and the accompanying drawings, wherein like elements are represented by like reference numerals, which are given by way of illustration only and thus are not limiting of the example implementations.

FIG. 1 illustrates a system for traversing a real-world environment using a map according to an example implementation.

FIG. 2 illustrates a block diagram of a signal flow for bundle adjustment according to an example implementation.

FIG. 3 illustrates a block diagram of a head-mounted device according to an example implementation.

FIG. 4 is a block diagram of a method of marginalizing keyframes according to an example implementation.

FIG. 5 is a block diagram of a method of operating a device according to an example implementation.

It should be noted that these Figures are intended to illustrate the general characteristics of methods, and/or structures utilized in certain example implementations and to supplement the written description provided below. These drawings are not, however, to scale and may not precisely reflect the precise structural or performance characteristics of any given implementation and should not be interpreted as defining or limiting the range of values or properties encompassed by example implementations. For example, the positioning of modules and/or structural elements may be reduced or exaggerated for clarity. The use of similar or identical reference numbers in the various drawings is intended to indicate the presence of a similar or identical element or feature.

### DETAILED DESCRIPTION

Devices and/or applications executing on a device can traverse (e.g., move within) a real-world environment using a map of the real-world environment. The map can be generated using a plurality of images (often called keyframes) stored in a memory. Keyframes can also be referred to as, or include image data. The map can include a landmark(s). The landmark can be identified in one or more of the plurality of images. The landmark can be an object in the real-world environment. The landmark can be a stationary object. For example, the landmark can be a desk, a building, a wall, a tree, and the like. However, a landmark may not be a car, a person, an animal, and the like. In other words, a landmark may not be an object that moves often. An application executing on the device can be used to retrieve the map from a memory location. An application executing on the device can be used to collect data (sometimes called map data) to generate a map and/or modify a map. The data can include image data (e.g., the plurality of images) and non-image data (e.g., location data and device data). The data collection can include data corresponding to the landmark(s). The data collection can include non-image data corresponding to the location associated with the real-world data. The data collection can include non-image data corresponding to a pose or pose data (e.g., orientation, rotation, and the like) of the device.

SLAM is technology for devices including, for example, robots, drones, and computing devices (including wearable devices) executing augmented reality (AR) applications to navigate and understand their surroundings. SLAM builds a map of the environment while simultaneously locating the device within that map. Keyframes, which are images of the real-world environment at key points in SLAM. Keyframing can be a technique configured to select specific images or frames to optimize the SLAM process which can reduce computational demand of the SLAM on the device.

However, these keyframes accumulate over time, leading to an ever-growing map size. At least one technical problem is that the accumulation of keyframes can be a challenge in resource-constrained environments such as mobile robots, wearable devices (such as AR/VR headsets or glasses) and smartphones, where memory and processing power are limited. At least one technical problem is that in AR applications using headsets, large map sizes can affect rendering performance and ultimately degrade the user experience. Accordingly, efficiently managing keyframe selection and maintaining a compact map size can be desirable for optimizing performance and resource utilization across various applications.

Existing solutions address the issue of map size in SLAM by adopting two primary techniques. The first is removing existing keyframes and the second is preventing the updating of (referred to as freezing) existing keyframes. Removing existing keyframes involves deleting those deemed less informative or redundant based on specific criteria like the number of observed landmarks or proximity to other keyframes. Removing existing keyframes reduces map size. However, at least one technical problem with removing existing keyframes is it can lead to the loss of valuable information, particularly when revisiting previously explored areas or performing loop closures. At least one technical problem with removing keyframes is it can disrupt the consistency of the map, potentially impacting the accuracy and stability of the SLAM system.

Freezing existing keyframes can mitigate information loss by keeping them in the map but preventing further updates to their pose or landmark associations. Freezing existing keyframes can maintain consistency in the map. However, at least one technical problem with freezing existing keyframes is it fails to address the underlying problem of the increased memory requirements. At least one technical problem with freezing existing keyframes is that frozen keyframes can still contribute to computational complexity during optimization steps in the SLAM process, hindering overall performance.

Both methods, despite their attempts to control map size, fall short in addressing the core issue of efficient keyframing while preserving essential information and maintaining map consistency. They either compromise map accuracy and stability through information loss or fail to offer significant improvements in memory and computational efficiency. This highlights the need for a more sophisticated solution that balances these competing priorities effectively.

At least one technical solution includes using spatial keyframing or spatial keyframe marginalization. In some implementations spatial keyframing involves marginalizing older batches of keyframes when a new batch of keyframes covers roughly the same position and/or orientation. Marginalization can include removing old and/or duplicate data. As keyframes arrive they are batched (e.g., grouped) into epochs (e.g., a period of time over which data (e.g., keyframes) are collected and/or batched). Some of the keyframes in the epoch may be marginalized and thus are not considered for spatial keyframing. Each batch from a single epoch is stored for consideration in spatial keyframing. When a new batch of keyframes arrives, the new batch is compared to the previous eligible (e.g., keyframes that cover roughly the same position and/or orientation) batches. If the poses of the new and existing keyframes are close enough (e.g., meeting criteria on the number of keyframes within both position and orientation difference limits) then the existing batch of keyframes (e.g., the keyframes or existing keyframes meeting the criteria) can be marginalized and/or removed from the list of keyframe batches eligible for spatial keyframing. In some implementations, marginalizing the previous keyframes involves replacing all bundle adjustment costs associated with those keyframes with a single linear constraint that summarizes the visual and inertial constraints produced by those keyframes.

For example, the keyframes can produce costs which are minimized in an optimization problem. Specifically, a common cost involves the distance in the image (in pixels) between where a landmark was seen in the image and the projection of the landmark into the image (given the landmark position, keyframe pose, and camera model). For some keyframes and landmarks, this can get complicated and/or costly. Marginalization can involve replacing the complicated costs with something simpler, but which constrains the keyframes on either side in approximately the same way as the original complicated costs.

At least one technical effect is that marginalizing the existing keyframes reduces the size of the bundle adjustment problem compared to using all the keyframes or freezing them. At least one technical effect is that marginalizing the existing keyframes retains the essential information of the inertial and visual constraints while using only a fraction of the computing resources.

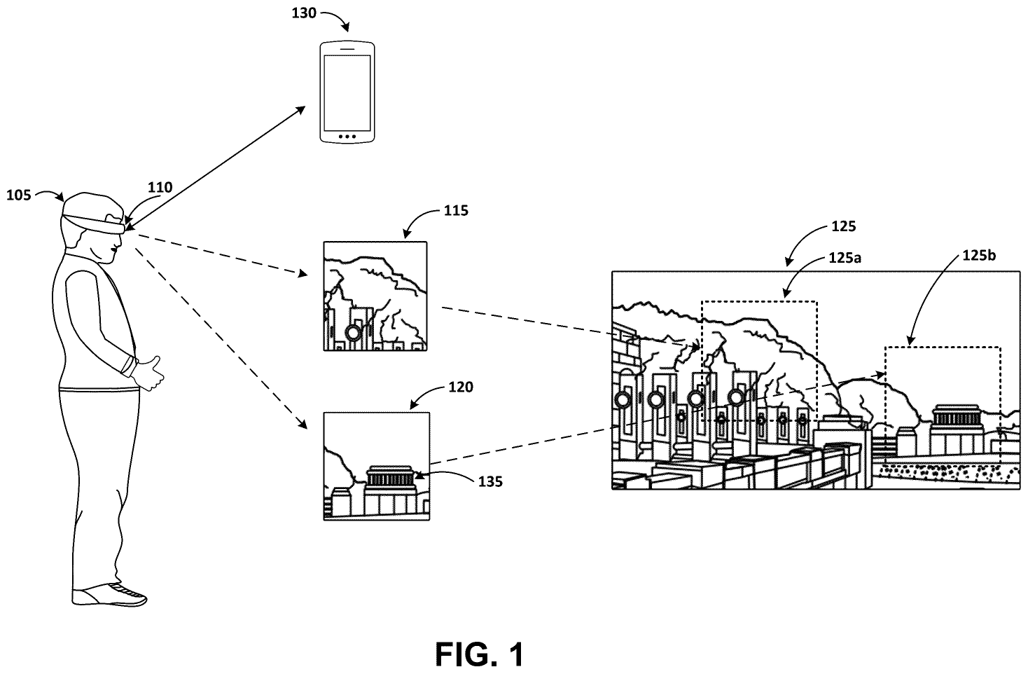

FIG. 1 illustrates a system for traversing a real-world environment using a map according to an example implementation. The system can be configured to use a SLAM system while traversing the real-world environment. The system can be configured to use marginalization to optimize the SLAM system. The system can be configured to use keyframing in marginalization. The system can be configured to selectively choose images or keyframes to selectively marginalize keyframes. In some implementations spatial keyframing involves marginalizing older batches of keyframes when a new batch of keyframes covers roughly the same position and/or orientation.

As shown in FIG. 1, the system includes a user 105, a device 110, and a companion device 130. Also shown in FIG. 1 is a first portion 125a of a real-world environment 125, a second portion 125b of the real-world environment 125. Device 110 can be configured to generate image data 115 representing the first portion 125a of the real-world environment 125 and image data 120 representing the second portion 125b of the real-world environment 125. The device 110 can be configured to generate pose data (sometimes referred to as inertial data) (not shown) representing movement of the device 110 and/or the user 105 from viewing the first portion 125a of the real-world environment 125 and viewing the second portion 125b of the real-world environment 125. Pose data can include position and orientation (pitch, yaw and roll) of device 110.

The device 110 can be a wearable device. For example, device 110 can be a smart glasses device (e.g., AR glasses device), a head mounted display (HMD), a computing device, a wearable computing device, and the like. Device 110 can be a standalone movable device. For example, device 110 can be a robot, a drone, and the like. User 105 can be viewing a real-world view in any direction (note that standalone movable devices may not be worn by a user). The device 110 can be configured to generate an image of the real-world environment 125. The image data 115 representing the first portion 125a of the real-world environment 125 and image data 120 representing the second portion 125b of the real-world environment 125 can be generated based on the image. As mentioned above, an image can include a landmark. For example, image data 120 can include a landmark 135 (e.g., a building).

In some implementations, device 110 can be configured to perform the processing described herein. However, the companion device 130 (e.g., a computing device, a mobile phone, a tablet, a laptop computer, and/or the like) can be configured to receive (e.g., via a wired and/or wireless connection) the image data 115, image data 120 representing, and/or the pose data. The image data 115, image data 120, and/or the pose data can be further processed by the companion device 130.

A motion monitoring system (sometimes called a front-end motion tracking system) can be configured to provide captured feature descriptors and estimated device pose to a back-end mapping system. The back-end mapping system can be a six degree of freedom (6DoF) mapping system. The back-end mapping system can be configured to store a plurality of maps based on stored feature descriptors. The back-end mapping system can be configured to periodically receive additional feature descriptors and estimated device poses from the front-end motion tracking system as they are generated while the device moves through the environment. The back-end mapping system can be configured to build a visual representation (map) of the environment based on the stored plurality of maps and the received feature descriptors. The back-end mapping system can be configured to build a three-dimensional (3D) visual representation (3D map) of the environment based on the stored plurality of maps and the received feature descriptors. The back-end mapping system can be configured to provide the visual representation and/or 3D visual representation of the environment to a localization system, which compares generated feature descriptors to stored feature descriptors from the stored plurality of maps and identifies correspondences between stored and observed feature descriptors.

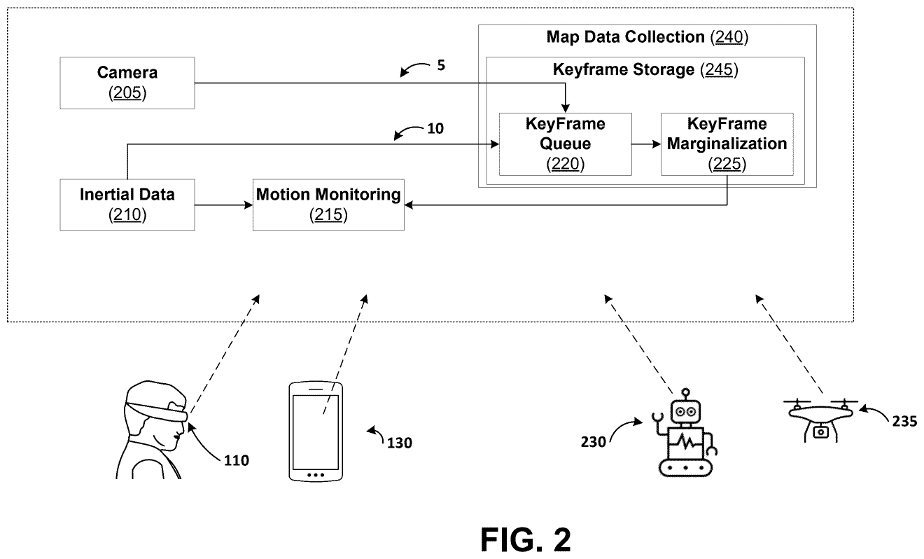

FIG. 2 illustrates a block diagram of a signal flow for bundle adjustment according to an example implementation. As shown in FIG. 2, the signal flow includes a camera 205 block, an inertial data 210 block, a motion monitoring 215 block, a keyframe queue 220 block, and a keyframe marginalization 225 block. The keyframe queue 220 block, and a keyframe marginalization 225 block can be included in a keyframe storage 245 block. The keyframe queue 220 can be configured to receive image data 5 from the camera 205 and inertial data 10 from the inertial data 210. Non-image data can include inertial data 10. However, in some implementations, non-image data can be obtained from the camera 205 as well. As shown in FIG. 2, device 110 can perform the signal flow. As shown in FIG. 2, companion device 130 can perform the signal flow. As shown in FIG. 2, a robot device 230 can perform the signal flow. As shown in FIG. 2, a drone device 235 can perform the signal flow. As shown in FIG. 2, device 110 and companion device 130 together can perform the signal flow. As shown in FIG. 2, robot device 230 and companion device 130 together can perform the signal flow. As shown in FIG. 2, drone device 235 and companion device 130 together can perform the signal flow. In some implementations, the device 110 (e.g., wearable device), companion device 130, robot device 230, and drone device 235 are just example devices. Other devices can perform the functions described herein.

As shown in FIG. 2, camera 205 can be configured to capture (e.g., sense, generate, and the like) image data (e.g., of the real-world environment 125, image data 115, image data 120, and/or the like). Camera 205 can be associated with (e.g., an element of) a device or computing device (e.g., device 110, robot device 230, drone device 235, and/or the like). In some implementations, camera 205 can be a forward-looking camera of the computing device (e.g., a wearable device). In some implementations, camera 205 can be configured to capture image data associated with, for example, a real-world environment and/or at least a portion of a real-world environment. The real-world environment can be associated with the direction and/or a pose of the device (e.g., device 110, robot device 230, drone device 235, and/or the like).

Inertial data 210 can be data associated with the movement of a device. For example, inertial data 210 can be used in a pose monitoring system associated with a device (e.g., device 110, robot device 230, drone device 235, and/or the like). Pose can include position and orientation (pitch, yaw and roll). Therefore, pose data can include position and orientation (pitch, yaw and roll) of the device. Pose monitoring can include the monitoring of position and orientation (pitch, yaw and roll) of the device 110. Therefore, inertial data can include data associated with 6DoF monitoring of the device. Inertial data can be associated with simultaneous localization and mapping (SLAM) and/or visual-inertial odometry (VIO).

Inertial data 210 can include, for example, data captured by an inertial measurement unit (IMU) of the device. In some implementations, inertial data 210 can further include calibration data (e.g., of motion devices), range sensor data, camera rolling shutter information, camera zooming information, and/or other sensor data. In some implementations, inertial data 210 can be generated and/or captured by a companion device (e.g., companion device 130). The motion monitoring 215 block can be configured to generate motion monitoring data based on inertial data 210. The motion monitoring data can correspond to movement of the device within, or relative to, the real-world environment or at least a portion of the real-world environment. The movement can represent movement of the device with respect to the real-world environment or at least a portion of the real-world environment.

Mapping a real-world environment can include using an application configured to provide instructions to a user of a device (e.g., AR/VR/MR device, a robot, and the like) during data collection, hereinafter referred to as a map data collection 240. The map data collection 240 can be an element of the aforementioned back-end mapping system. The keyframe data collection 240 can include a keyframe storage 245 block. The map data collection 240 can be used by software developers and content creators. The map data collection 240 can be configured to generate (or help generate) three-dimensional (3D) content at real-world locations. The map data collection 240 can be configured to obtain image data and non-image data, store image data and non-image data in relation to a map, and marginalize image data and non-image data. The map data collection 240 can be included in user software (e.g., for playback of the 3D content) to collect data (e.g., location data, keyframes) when a user of a device (e.g., AR/VR/MR device, a robot, and the like) is using the software including the application in the associated real-world location. The provided instructions can ensure that all spaces are covered, and the data is sufficient for creating a high-quality feature map.

The keyframing strategy of the back-end mapping system adds new keyframes over time unless the device is stationary. The map data collection 240 can be configured to implement the keyframing strategy of the back-end mapping system. Since the mapping processing cost directly relates to the number of keyframes, this results in unbounded memory growth and CPU/battery usage for the room-scale virtual reality (VR) and augmented reality (AR) use cases.

To address the issue of unbounded memory growth caused by current keyframing strategies, implementations may put one or more optimizations in place to handle large map size, long solves, and running out of RAM. The optimizations include:
1. The marginalization strategy employed by 6DoF is to keep 5 consecutive keyframes and marginalize the next 20 consecutive keyframes every epoch.
2. Perform a map split when 3 consecutive map solves take longer than 5 seconds each.
3. Perform a map split when a memory usage estimate for the map solve exceeds 100 Mb.
4. When the native memory used by the app reaches 1 GB, the system may stop mapping completely.

The first optimization can reduce the memory and CPU usage but may not prevent the map from growing. The next two optimizations can be configured to prevent the mapping backend from falling behind the input data or exceeding the memory budget. The last optimization can be configured to terminate mapping and may lead to a portion of the environment not being mapped even in the room-scale case and result in drift and poor user experience. However, if the device keeps moving in front of the same scene, the tracking processing cost may increase over time until it reaches the limit and causes a map split.

Some implementations can incrementally optimize the keyframing/marginalization strategy in order to reduce the steady growth of memory and CPU usage by the 6DoF stack over the long sessions in the same physical area (room-scale use case). Some implementations can simultaneously maintain high quality of tracking. Some implementations can generate bounded map growth when tracking in the same physical space, resulting in a fixed memory budget and predictable CPU/battery usage.

Some implementations can reduce the growth rate of the map as new keyframes are added. Some implementations can reduce the growth rate by marginalizing previous spatially redundant keyframes in the trajectory. In some implementations, spatially redundant keyframes can be keyframes that cover roughly and/or substantially the same position and/or orientation. The position can be related to the location associated with the keyframe. For example, the position can be a location of the device that captured the image data corresponding to the keyframe. The location of the device can be represented by location data. The location data can include, for example, latitude and longitude data, an address, a floor, and the like. The orientation can be related to a pose of the device while capturing the image corresponding to the keyframe. For example if a device moves around within the same area, the concurrent odometry and mapping system (COM) (or COM system) processing cost and memory usage may be bound and may not increase over time. Some implementations can be configured to keep a fixed number of keyframes, and this raises two technical issues.

The first technical issue is determining how keyframes are removed. In some implementations keyframes can be dropped. This option does not require any processing but may leave IMU links (arising from IMU measurements) between remaining keyframes and thus can affect the system stability. In some implementations the keyframe marginalization 225 can be configured to remove these keyframes out using, for example, the Schur complement method. The Schur complement method in SLAM marginalization is a technique used to eliminate a subset of variables (e.g., past robot poses or landmarks) from the optimization problem while preserving the information they provide about the remaining variables, effectively reducing the computational cost of solving the SLAM problem. In some implementations the keyframe marginalization 225 can be configured to marginalized keyframes using the COM approximate marginalization strategy (CKLAM). CKLAM is a method of SLAM that marginalizes out non-keyframes and non-landmarks. This method enables abstracting visual and inertial information corresponding to marginalized keyframes as a generalized constraint between two neighboring remaining keyframes, and thus does not introduce any extra solving time.

The second technical issue is determining which keyframes are going to be marginalized. Some implementations employ CKLAM marginalization. Therefore, the landmarks associated with marginalized keyframes may be lost. Therefore, to maintain map quality, in some implementations the keyframe marginalization 225 can be configured to marginalize existing keyframes when the device comes back to revisit the same area (e.g., spatial keyframing). By doing so, the number of keyframes will be fixed when tracking in a constrained area. In some implementations the keyframe marginalization 225 can be configured to marginalize existing keyframes, instead of the new added ones, because they have been optimized many times over the COM incremental optimizations, and thus marginalizing them out tends to cause less linearization errors.

The criterion for which of the previous keyframes to marginalize each epoch to maintain the map size can be a design choice. In some implementations the keyframe marginalization 225 can be configured to marginalize keyframes using different criteria. Different criteria represent different tradeoffs between the map growth rate and the quality of the resultant map or map data. More aggressive marginalization of existing keyframes in the map can result in some loss in tracking quality, but also uses less computational resources and memory. As such, different parameters could be used in different products/hardware, or even be adjusted at runtime based on the CPU/thermal load of the device.

In some implementations the keyframe marginalization 225 can be configured to obtain keyframes from the keyframe queue 220 and configured to add 25 new keyframes, optimize the map and then marginalize 20 out of 25 keyframes in each epoch. However, at the end of each epoch, for example, with five (5) new keyframes added, some implementations can include evaluating whether there is a previous batch of, for example, five (5) consecutive keyframes in the trajectory that are spatially close to the current epoch's five (5) keyframes. When such a batch exists, some implementations can include marginalizing keyframes. Some implementations can include making a decision to marginalize the entire batch of, for example, five (5) previous consecutive keyframes based on, for example, (1) CKLAM marginalization operates on observable landmarks. Therefore, each marginalized landmark can be seen from at least two (2) camera poses (corresponding to two (2) keyframes). (2) Marginalize, for example, every other keyframe may introduce more fill-ins in the resulting system. (3) Since, for example, five (5) new keyframes can be added in each epoch, to keep the number of total keyframes the same, some implementations can marginalize, for example, five (5) existing keyframes.

Spatially close can be substantially equivalent to spatially redundant when comparing two keyframes. In some implementations, spatially redundant keyframes can be keyframes that cover roughly and/or substantially the same position and/or orientation. The position can be related to the location associated with the keyframe. For example, the position can be a location of the device that captured the image corresponding to the keyframe. The orientation can be related to a pose of the device while capturing the image corresponding to the keyframe. Marginalization can include removing image data and removing non-image data associated with a keyframe.

### Spatial Proximity Strategy

In some implementations the keyframe marginalization 225 can be configured to use spatial thresholds for when to add a new keyframe. For example, a spatial threshold can be six (6) cm translation delta and/or five (5) degrees orientation delta with the previous keyframe. Some implementations can use a translation and orientation threshold to define spatially close keyframes for the purpose of marginalization. The criteria can be subject to tuning.

For two batches of, for example, five (5) keyframes in each, a proximity score can be assigned which is the sum of the number of spatially close keyframes in the second batch for each keyframe in the first batch. For example, the proximity score can be a number between 0 and 25. In some implementations, the proximity score can be used as a parameter to evaluate the performance of spatial keyframing. Further, a minimum number of spatially close batches can be set as another signal to marginalization. This signal tracks the number of times the trajectory visited a particular space. For example, the minimum number of spatially close batches equals, for example, two (2) with the proximity score of, for example, ten (10) can indicate to marginalize a previous batch of keyframes only if there are at least two (2) spatially close batches with the score of ten (10) or higher.

Spatially close can be substantially equivalent to spatially redundant when comparing two keyframes. In some implementations, spatially redundant keyframes can be keyframes that cover roughly and/or substantially the same position and/or orientation. The position can be related to the location associated with the keyframe. For example, the position can be a location of the device that captured the image corresponding to the keyframe. The orientation can be related to a pose of the device while capturing the image corresponding to the keyframe. Marginalization can include removing image data and removing non-image data associated with a keyframe.

### Visual Matching Strategy

In some implementations the keyframe marginalization 225 can be configured to use a visual matching strategy. In some implementations the new keyframes can match a group of existing keyframes if the keyframes have a sufficient number of commonly observed landmarks. As compared to the spatial proximity strategy, the visual matching strategy has two potential advantages: (1) The user may come back to a previously visited location, but the loop closure modules may fail to find feature matches. In such cases, marginalizing existing keyframes may lose the existing landmarks in the map. (2) When two user poses are far away, they may still observe the same scene (e.g., when the scene is far away). Marginalizing existing keyframes in this situation may be acceptable.

As with spatial matching, some implementations may be looking for a batch of, for example, five (5) existing keyframes that best visually matches the current epochs, for example, five (5) keyframes. Some implementations can use the following tunable parameters for the visual matching algorithm:
Visual overlap threshold: percentage of all landmarks observed from the, for example, five (5) existing keyframes that is also observed from the current epochs, for example, five (5) keyframes.
Minimum common landmarks: the minimum number of common landmarks observed from both existing and new keyframes. This is because if a certain number of landmarks are retained (e.g., three (3) landmarks in general, and two (2) landmarks when considering the known gravity direction), a device may be able to find its pose using the map.
Minimum surviving landmark ratio: the minimum percentage of all landmarks observed from the, for example, five (5) existing keyframes that remain valid after the keyframes get marginalized (valid means they are observed from at least, for example, five (5) poses).

In some implementations, a goal can be to find a batch of, for example, five (5) existing keyframes that maximize the visual overlap threshold while satisfying the minimum visual overlap threshold, common landmarks and surviving landmark ratio. For this test, global loop closure can be performed for every non-marginalized keyframe in the current epoch to maximize feature association and landmark merging.

### Removing Existing Keyframes

In some implementations the keyframe marginalization 225 can be configured to remove existing keyframes. In other words, keyframes stored in memory in association with a map(s) can be removed. When a user-created pose node (e.g., an AR anchor) is attached to a keyframe removed by an algorithm based on an example implementation, a re-attachment to a different keyframe should be performed in order to keep on being updated by a mapping system. If the removed pose node is not re-attached to another keyframe, the pose node may not be updated by the transformation deltas that the mapping system solves for. The following are three options to re-attach the pose node to another keyframe.

Option 1: Interpolate from a closest keyframe in time by using trajectory data from VIO. This option occurs when keyframes get marginalized. The only requirement is that there are some (or none) keyframes missing on after the keyframes are deleted.

Option 2: Interpolate from the closest keyframe in time by using trajectory from the mapping system. For this option, the same logic as option 1 can be followed. However, the latest optimized trajectory from the mapping system can be used. This requires a refactoring so the same logic can be used to interpolate on re-attachment but with respect to different base nodes. Option 1 can use the VIO pose node as base node and option 2 can use the latest map pose node as base node.

Option 3: Interpolate from the closest keyframe in space by using trajectory from the mapping system. This option can include attaching to a keyframe close in space instead of close in time. This is possible because the triggering cause of the deletion of keyframe can be that other keyframes close in space exist. This could keep the solve error low over time, as the fixed transformation would be smaller than the one in option 2.

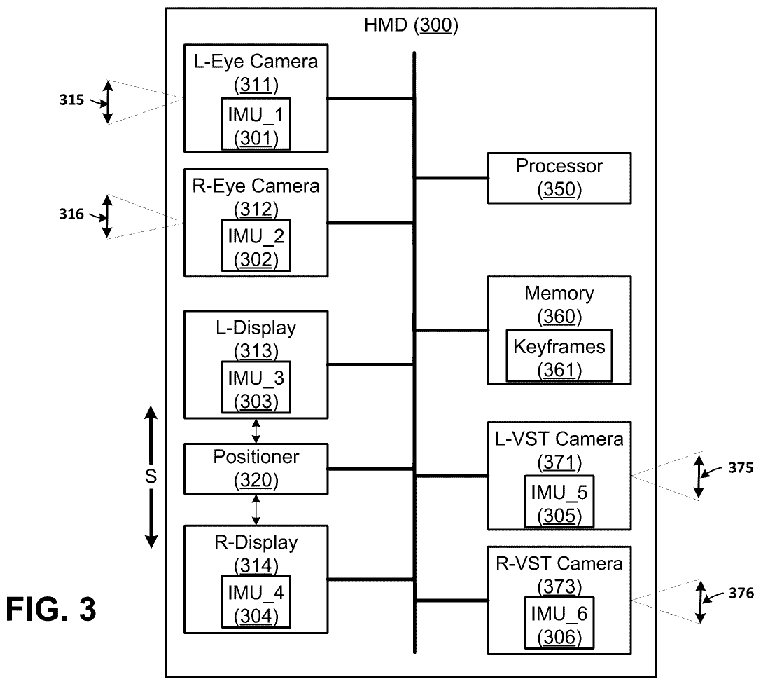

FIG. 3 is a block diagram of a head-mounted device according to a possible implementation of the present disclosure. The head-mounted device 300 includes a pair of world-facing cameras configured to capture stereoscopic images of an environment of a user wearing the head-mounted device. These world images can be displayed (along with virtual content) on a pair of stereoscopic displays so that the user observes the world through a video see-through interface.

The head-mounted device 300 includes a left video see-through (VST) camera (left-VST camera 371) with a left field of view (left FOV 375) directed to an environment of a user. The head-mounted device 300 further includes a right-VST camera 373 with a right FOV 376 directed to the environment. The left FOV 375 and the right FOV 376 may overlap so that the left-VST camera 371 and the right-VST camera 373 can generate stereoscopic content of the environment. The left-VST camera 371 includes a corresponding IMU (i.e., IMU_5 305, IMU_6 306) that is configured to track motion in a frame of reference corresponding to each camera.

The head-mounted device 300 further includes a left display 313 and a right display 314. The displays are arranged so that they can be positioned in front of a user's eyes while the user is wearing the head-mounted device 300. The displays are configured to present stereoscopic content (i.e., images) to a user so that the user can perceive depth via the stereoscopic effect. The left display is coupled to a left-display inertial measurement unit (IMU_3 303) and the right display is coupled to a right-display inertial measurement unit (IMU_4 304). The display IMUs are rigidly coupled to the displays so that movement of the display is sensed by their corresponding IMU. Additionally, the IMUs may be aligned with a coordinate system of the display so that a transformation between the frames of reference of the IMUs can be equivalent to the transformation between the frames of reference of the displays.

The displays may be mechanically coupled to a positioner 320. The positioner 320 may be configured to move either (or both) displays. For example, a processor 350 of the head-mounted device 300 may control the positioner 320 to move a prescribed amount to create a spacing between the displays (i.e., display spacing (S)).

It may be desirable for the spacing between the displays to approximately match (e.g., equal) the spacing between a user's eyes (i.e., eye spacing). Accordingly, the head-mounted device 300 may include eye-tracking cameras which can help determine the eye spacing based on positions of eye features (e.g., pupil) in the eye images captured by the eye-tracking cameras. The head-mounted device 300 includes a left eye-tracking camera 311 having a left eye FOV 315 directed to a left eye of the user and a right eye-tracking camera 312 having a right eye FOV 316 directed to a right eye of the user. A left eye-tracking IMU (IMU_1 301) may be mechanically coupled to the left eye-tracking camera 311 and a right eye-tracking IMU (IMU_2 302) may be mechanically coupled to the right eye-tracking camera 312.

The head-mounted device 300 further includes a memory 360. The memory may be a non-transitory computer-readable medium and may be configured to store instructions that, when executed by the processor 350, can configure the head-mounted device 300 to perform the disclosed methods. For example, the memory 360 may be configured to store keyframes 361 for generating at least one map.

The head-mounted device 300 may further include a communication interface (not shown). The communication interface may be configured to communicate information digitally over a wireless communication link (e.g., WIFI, BLUETOOTH, etc.). For example, the head-mounted device 300 may be communicatively coupled to a network (i.e., the cloud) or a device (e.g., mobile phone) over the wireless communication link. The wireless communication link may allow operations of a computer-implemented method to be divided between devices and/or could allow for remote storage of the keyframes 361. In a possible implementation, the head-mounted device 300 is smart glasses, such as augmented-reality glasses. In a possible implementation, the head-mounted device 300 is smart goggles, e.g., VR goggles.

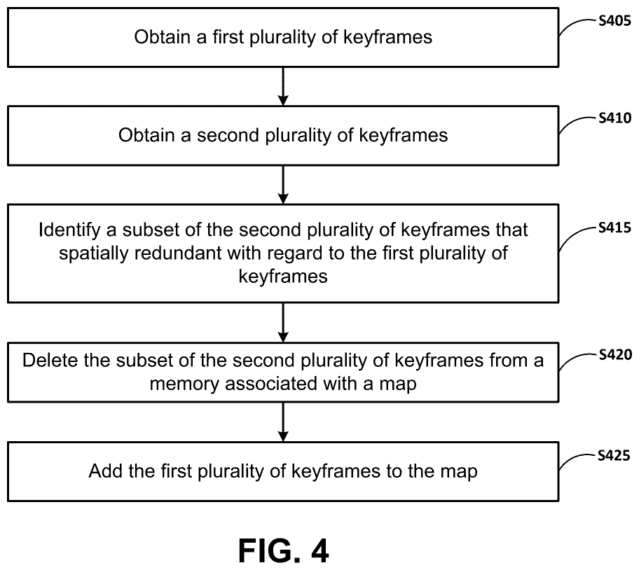

FIG. 4 is a block diagram of a method of marginalizing keyframes according to an example implementation. As shown in FIG. 4, in step S405 obtain a first plurality of keyframes. For example, the first plurality of keyframes can be associated with a device traversing a real-world environment. The device can include a camera. The real-world environment can have a corresponding map and map data. The first plurality of keyframes can correspond to images captured by the camera of the device. Obtaining the first plurality of keyframes can include receiving keyframes from the camera and storing the keyframes in a queue. Obtaining the first plurality of keyframes can include reading the keyframes from the queue. Reading the keyframes from the queue can be triggered by the queue having a threshold number of keyframes in the queue. The first plurality of keyframes can be referred to as a batch of keyframes.

In step S410 obtain a second plurality of keyframes. For example, as mentioned above, the real-world environment can have a corresponding map and map data. The map data can be stored in a memory. The map data can include a plurality of keyframes. The keyframes can have corresponding non-image data. The non-image data can include, for example, pose data, inertial data, spatial data, and/or the like.

In step S415 identify a subset of the second plurality of keyframes that are spatially redundant with regard to the first plurality of keyframes. For example, spatially redundant can refer to a comparison of two keyframes. The comparison can be based on the location associated with the keyframes where spatial or spatially can correspond to the location. Redundant can indicate the two keyframes represent substantially (e.g., close enough to generate an accurate map) the same location. In some implementations, spatially redundant keyframes can be keyframes that cover roughly and/or substantially the same position and/or orientation. The position can be related to the location associated with the keyframe. For example, the position can be a location of the device that captured the image corresponding to the keyframe. The orientation can be related to a pose of the device while capturing the image corresponding to the keyframe.

In step S420 delete the subset of the second plurality of keyframes from a memory associated with a map. For example, if two keyframes represent substantially the same location, there may be no need to retain both keyframes in order to generate an accurate map. Therefore, one of the keyframes can be discarded. In some implementations, the subset of the second plurality of keyframes is the older, existing, and/or stored keyframes. Therefore, the subset of the second plurality of keyframes can be discarded. Therefore, the subset of the second plurality of keyframes can be deleted from the memory and no longer be associated with the map.

In step S425 add the first plurality of keyframes to the map. For example, the first plurality of keyframes can be stored in a memory associated with the map. In other words, the first plurality of keyframes can be stored and related with the map in place of the subset of the second plurality of keyframes.

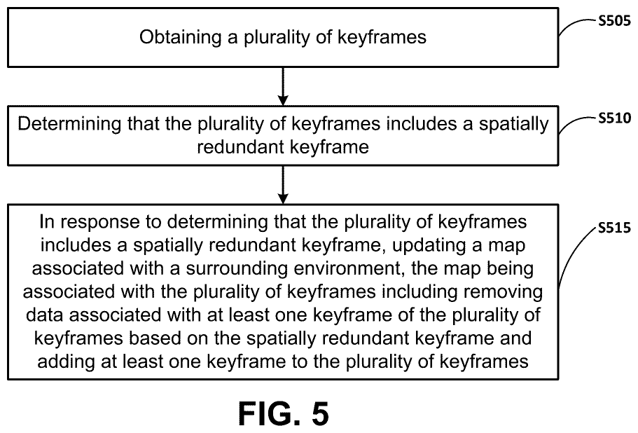

Example 1. FIG. 5 is a block diagram of a method of operating a device according to an example implementation. As shown in FIG. 5, in step S505 obtaining a plurality of keyframes. In step S510 that the plurality of keyframes includes a spatially redundant keyframe In step S515 in response to determining that the plurality of keyframes includes a spatially redundant keyframe, updating a map associated with a surrounding environment, the map being associated with the plurality of keyframes including removing data associated with at least one keyframe of the plurality of keyframes based on the spatially redundant keyframe and adding at least one keyframe to the plurality of keyframes.

Example 2. The method of Example 1, wherein the determining that the plurality of keyframes can include a spatially redundant keyframe can include determining that a previous batch of keyframes in a trajectory are spatially close to a current batch of keyframes.

Example 3. The method of Example 2, wherein spatially close can be based on a translation threshold and an orientation threshold.

Example 4. The method of Example 2, wherein spatially close can be based on a visual overlap threshold.

Example 5. The method of Example 4, wherein the visual overlap threshold can be based on a number of common landmarks.

Example 6. The method of Example 2, wherein spatially close can be based on non-image data.

Example 7. The method of Example 6, wherein non-image data can include at least one of location data, device data, pose data, orientation, and rotation.

Example 8. The method of Example 1, wherein the plurality of keyframes can include a first plurality of keyframes captured by a device and a second plurality of keyframes associated with the map and determining that the plurality of keyframes includes a spatially redundant keyframe can include identifying a subset of the second plurality of keyframes that are spatially redundant with regard to the first plurality of keyframes.

Example 9. The method of Example 8, wherein the removing of the data associated with the at least one keyframe can include deleting the subset of the second plurality of keyframes.

Example 10. The method of Example 8, wherein the adding of the at least one keyframe to the plurality of keyframes can include adding the first plurality of keyframes to the plurality of keyframes.

Example 11. A method can include any combination of one or more of Example 1 to Example 10.

Example 12. A non-transitory computer-readable storage medium comprising instructions stored thereon that, when executed by at least one processor, are configured to cause a computing system to perform the method of any of Examples 1-11.

Example 13. An apparatus comprising means for performing the method of any of Examples 1-11.

Example 14. An apparatus comprising at least one processor and at least one memory including computer program code, the at least one memory and the computer program code configured to, with the at least one processor, cause the apparatus at least to perform the method of any of Examples 1-11.

Example implementations can include a non-transitory computer-readable storage medium comprising instructions stored thereon that, when executed by at least one processor, are configured to cause a computing system to perform any of the methods described above. Example implementations can include an apparatus including means for performing any of the methods described above. Example implementations can include an apparatus including at least one processor and at least one memory including computer program code, the at least one memory and the computer program code configured to, with the at least one processor, cause the apparatus at least to perform any of the methods described above.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

While example implementations may include various modifications and alternative forms, implementations thereof are shown by way of example in the drawings and will herein be described in detail. It should be understood, however, that there is no intent to limit example implementations to the particular forms disclosed, but on the contrary, example implementations are to cover all modifications, equivalents, and alternatives falling within the scope of the claims. Like numbers refer to like elements throughout the description of the figures.

Some of the above example implementations are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example implementations. Example implementations, however, may be embodied in many alternate forms and should not be construed as limited to only the implementations set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example implementations. As used herein, the term and/or includes any and all combinations of one or more of the associated listed items.

It will be understood that when an element is referred to as being connected or coupled to another element, it can be directly connected or coupled to the other element or intervening elements may be present. In contrast, when an element is referred to as being directly connected or directly coupled to another element, there are no intervening elements present. Other words used to describe the relationship between elements should be interpreted in a like fashion (e.g., between versus directly between, adjacent versus directly adjacent, etc.).

The terminology used herein is for the purpose of describing particular implementations only and is not intended to be limiting of example implementations. As used herein, the singular forms a, an and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example implementations belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example implementations and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative implementations, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example implementations are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example implementations are not limited by these aspects of any given implementation.

What is claimed is:

1. A method comprising:
obtaining a plurality of keyframes;
determining that the plurality of keyframes includes a spatially redundant keyframe; and
in response to determining that the plurality of keyframes includes a spatially redundant keyframe, updating a map associated with a surrounding environment, the map being associated with the plurality of keyframes, including:
removing data associated with at least one keyframe of the plurality of keyframes based on the spatially redundant keyframe, and
adding at least one keyframe to the plurality of keyframes.

2. The method of claim 1, wherein determining that the plurality of keyframes includes a spatially redundant keyframe includes determining that a previous batch of keyframes in a trajectory are spatially close to a current batch of keyframes.

3. The method of claim 2, wherein spatially close is based on a position threshold and orientation threshold.

4. The method of claim 2, wherein spatially close is based on a visual overlap threshold.

5. The method of claim 4, wherein the visual overlap threshold is based on a number of common landmarks.

6. The method of claim 2, wherein spatially close is based on non-image data.

7. The method of claim 6, wherein the non-image data includes at least one of location data, device data, pose data, orientation, and rotation.

8. The method of claim 1, wherein
the plurality of keyframes includes:
a first plurality of keyframes captured by a device, and
a second plurality of keyframes associated with the map; and
determining that the plurality of keyframes includes a spatially redundant keyframe includes identifying a subset of the second plurality of keyframes that are spatially redundant with regard to the first plurality of keyframes.

9. The method of claim 8, wherein the removing of the data associated with the at least one keyframe includes deleting the subset of the second plurality of keyframes.

10. The method of claim 8, wherein the adding of the at least one keyframe to the plurality of keyframes includes adding the first plurality of keyframes to the plurality of keyframes.

11. An apparatus comprising at least one processor and at least one memory including computer program code, the at least one memory and the computer program code configured to, with the at least one processor, cause the apparatus to:
obtain a plurality of keyframes;
determine that the plurality of keyframes includes a spatially redundant keyframe; and
in response to determining the plurality of keyframes includes a spatially redundant keyframe, update a map associated with a surrounding environment, including:
removing data associated with at least one keyframe of the plurality of keyframes based on the spatially redundant keyframe, and
adding at least one keyframe to the plurality of keyframes.

12. The apparatus of claim 11, wherein determining that the plurality of keyframes includes a spatially redundant keyframe includes determining that a previous batch of keyframes in a trajectory are spatially close to a current batch of keyframes.

13. The apparatus of claim 12, wherein spatially close is based on a position threshold and orientation threshold.

14. The apparatus of claim 12, wherein spatially close is based on a visual overlap threshold.

15. The apparatus of claim 14, wherein the visual overlap threshold is based on a number of common landmarks.

16. The apparatus of claim 12, wherein spatially close is based on non-image data.

17. The apparatus of claim 16, wherein non-image data includes at least one of location data, device data, pose data, orientation, and rotation.

18. The apparatus of claim 11, wherein
the plurality of keyframes includes:
a first plurality of keyframes captured by a device, and
a second plurality of keyframes associated with the map; and
determining that the plurality of keyframes includes a spatially redundant keyframe includes identifying a subset of the second plurality of keyframes that spatially redundant with regard to the first plurality of keyframes.

19. The apparatus of claim 18, wherein
the removing of the data associated with the at least one keyframe includes deleting the subset of the second plurality of keyframes, and
the adding of the at least one keyframe to the plurality of keyframes includes adding the first plurality of keyframes to the plurality of keyframes.

20. A non-transitory computer-readable storage medium comprising instructions stored thereon that, when executed by at least one processor, are configured to cause a computing system to:
obtain a plurality of keyframes;
determine that the plurality of keyframes includes a spatially redundant keyframe; and
in response to determining the plurality of keyframes includes a spatially redundant keyframe, update a map associated with a surrounding environment, including:
removing data associated with at least one keyframe of the plurality of keyframes based on the spatially redundant keyframe, and
adding at least one keyframe to the plurality of keyframes.
